(19) United States
(12) Patent Application Publication
(10) Pub. No.: US 2011/0068189 A1
(43) Pub. Date: Mar. 24, 2011

(54) METHOD FOR ACTIVATING A PIEZOACTUATOR IN A FUEL INJECTOR

(76) Inventor: Martin Hopp, Regensburg (DE)

(21) Appl. No.: 12/988,576

(22) PCT Filed: Mar. 20, 2009
(86) PCT No.: PCT/EP2009/053313

§ 371 Date: Dec. 1, 2010

(30) Foreign Application Priority Data
Apr. 25, 2008 (DE) 102008020931.7

(51) Int. Cl. F02D 1/06

(52) U.S. Cl. 239/5

(57) ABSTRACT

In an activation method, a predetermined idle stroke (h0) is set between an actuator base plate (7) and an actuating element (3), depending on a predetermined initial position of the actuator base plate before activation. In order to stabilize oscillation-prone initial positions, thus improving injection accuracy, activating the piezoactuator (1) directly before injection is proposed such that a defined predeflection occurs such that the actuator base plate (7) assumes a new, less oscillation-prone initial position before the subsequent injection. In order to bring about the predeflection, negative current is applied to the piezoactuator (1) such that the actuator base plate (7) is retracted into a defined new initial position.

### CROSS-REFERENCE TO RELATED APPLICATIONS

This application is a U.S. National Stage Application of International Application No. PCT/EP2009/053313 filed Mar. 20, 2009, which designates the United States of America, and claims priority to German Application No. 10 2008 020 931.7 filed Apr. 25, 2008, the contents of which are hereby incorporated by reference in their entirety.

### TECHNICAL FIELD

The invention relates to a method for activating a piezoactuator in a fuel injector, wherein the electrically activatable piezoactuator transmits a longitudinal movement (stroke) to an actuating element, with a predetermined idle stroke being set between an actuator base plate and the actuating element, as a function of a predetermined initial position of the actuator base plate before activation.

### BACKGROUND

Such a method is known for example from DE 199 05 340 C2.

To supply fuel to internal combustion engines, common rail fuel injection systems are used, which operate at high injection pressures and fast switching speeds. With such systems fuel is conveyed by means of a high-pressure pump into a high-pressure accumulator, from which the fuel is injected out into the respective cylinder with the aid of fuel injectors. The fuel injector features an injection valve, which is opened and closed by a servo valve, to establish the temporal profile of the injection process into the combustion chamber. The servo valve is actuated here by an electrically activated piezoactuator, in which a longitudinal extension is produced by applying electrical voltage. This extension is transmitted to the servo valve, which in turn controls the injection valve. For the longitudinal extension of the piezoactuator, which is in the pm range, to be able to actuate the servo valve appropriately, said longitudinal extension is amplified for example mechanically by means of a lever transmission system supported in the fuel or hydraulically by means of a pressure chamber.

In order to be able to achieve the fast switching speeds and small injection quantities required in the fuel injector for an optimum combustion profile, it is necessary to set the injector very precisely. This applies in particular to the idle stroke resulting in the injector between the piezoactuator and the actuating element (servo valve).

Essentially the aim in most applications is for approximately the entire stroke of the piezoactuator also to be used for the mechanical movement of the control element, since size increases with the required stroke. It would follow from this that the play (idle stroke) between the piezoactuator and the actuating element should be kept as small as possible. On the other hand there must always be a minimum play between the actuator and the actuating element in the form of an idle stroke, in order to prevent operational malfunctions and to ensure the operational reliability of the injector. Therefore the current practice is generally to proceed so that when the actuator and actuating element are assembled, the idle stroke is set so that the required minimum play is present even in the most unfavorable conditions and known ageing effects (wearing in, settling and the like) are taken into account as far as possible.

Based on such a method for setting the idle stroke between a piezoactuator and a transmission element of a valve, which is typically implemented once during assembly, a method for setting and monitoring a predetermined idle stroke during operation of the piezoactuator is also known from the abovementioned patent. A direct current voltage is supplied here to at least some of the piezoelements of the piezoactuator, bringing about a change in the length of the piezoactuator which is independent of the activation voltage and which is intended to compensate for a change in the idle stroke due to ageing and temperature effects.

The applicant has anyway established that in addition to such production variances, which bring about very slow changes in the idle stroke compared with the dynamic operation of the piezoactuator, fast changes in the idle stroke also occur, which are clearly a function of the immediate dynamic previous history, in other words the previous injection. This is based on the fact the idle stroke is also determined by the position of the actuator base plate before injection, which thus also determines the injection characteristics of the injectors. The stable initial position of the actuator base plate is therefore a prerequisite for a reproducible stable minimum quantity injection. However in the case of multiple injections in particular different base plate positions are set as the initial position, these in turn leading to non-stable minimum quantities. This is due for example to creepage and domain folds of the piezoactuator, internal stresses in the membrane, membrane space pressure fluctuations and friction forces.

### SUMMARY

According to various embodiments, a method can be created, with which the oscillation-prone initial position assumed by the actuator base plate before injection can be stabilized. According to an embodiment, in a method for activating a piezoactuator in a fuel injector, wherein the electrically activatable piezoactuator transmits a longitudinal movement to an actuating element, with a predetermined idle stroke being set between an actuator base plate and the actuating element, as a function of a predetermined initial position of the actuator base plate before activation, the piezoactuator, the actuator base plate of which is in the predetermined oscillation-prone initial position, is activated directly before injection so that a defined predeflection of the piezoactuator occurs, such that the actuator base plate assumes a new, less oscillation-prone initial position before the subsequent injection.

According to a further embodiment, negative current can be applied to the piezoactuator to bring about the predeflection, so that the actuator base plate is retracted into a defined new position. According to a further embodiment, for activation purposes the piezoactuator can be subjected in each instance to an applied current profile, which brings about the defined predeflection and the subsequent injection, the start of current application being moved so far forward that a predetermined hydraulic opening time of a valve of the injector is achieved despite predeflection. According to a further embodiment, the charging current profile of the piezoactuator over time can be influenced by way of the parameters of the current application profile so that the desired positions of the actuator base plate are assumed at the desired times.

### BRIEF DESCRIPTION OF THE DRAWINGS

FIG. 1 shows a schematic and sectional view of a structure of a conventional valve controller with a piezoactuator,

FIG. 2 shows a time diagram of the actuator base plate position of a conventional piezoactuator activated,

FIG. 3 shows the actuator base plate position of an activated piezoactuator according to various embodiments.

### DETAILED DESCRIPTION

According to various embodiments, the piezoactuator, the actuator base plate of which is in the predetermined oscillation-prone initial position, is activated directly before injection so that a defined predeflection of the piezoactuator occurs, such that the actuator base plate assumes a new, less oscillation-prone initial position before the subsequent injection.

According to various embodiments, the actuator base plate is not returned cleanly to the predetermined initial position due to the highly dynamic forces acting during an injection event and therefore subjects the actuator base plate to an additional large force, in order to establish a virtual stop (new initial position) for the actuator base plate with defined, stabilized positional conditions by means of electrical activation. The method according to various embodiments, which is advantageously based solely on modification of the activation signal, allows precise small quantities to be achieved with multiple injections and therefore strict legal standards to be complied with in respect of exhaust gas values.

One embodiment may be particularly preferred, in which negative current is applied to the piezoactuator to bring about the predeflection, so that the actuator base plate is retracted into a defined new position.

According to one embodiment, this can be implemented in a simple manner in that for activation purposes the piezoactuator is subjected in each instance to an applied current profile, which brings about the defined predeflection and the subsequent injection, the start of current application being moved so far forward that a predetermined hydraulic opening time of a valve of the injector is achieved despite predeflection. According to one embodiment, the charging current profile of the piezoactuator here can be influenced by way of the parameters of the current application profile so that the desired positions of the actuator base plate are assumed at the desired times.

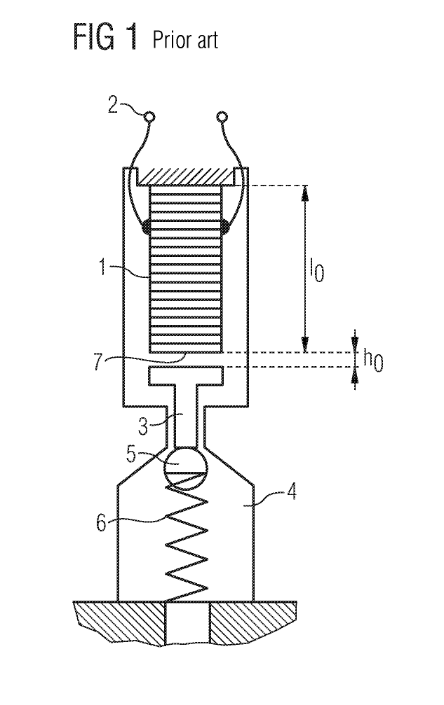

FIG. 1 of the drawing shows a schematic and exemplary view of the structure of a valve controller with an electric piezoactuator 1, which consists of a stack of plate-type piezoelectric elements, which are terminated in the direction of the valve by an actuator base plate 7. In the embodiment shown mechanical deflection takes place when a voltage is applied perpendicular to the layer plane of the individual piezoelements, in other words in the longitudinal direction (z-direction) of the piezoactuator 1.

In the rest position, in other words when no activation voltage is present, the piezoactuator 1 has length l₀, with the actuator base plate 7 assuming its predetermined initial position. The distance between the unextended piezoactuator 1 and a mechanical control or actuating element (in this instance a valve piston 3) is the idle stroke h₀. When an electric voltage is applied to the terminals 2 of the piezoactuator 1, it extends in the z-direction and takes on a length l₁, where l₁>1₀+h₀.

In the state shown in FIG. 1, because no electric voltage is applied, the piezoactuator 1 is in its rest position, the valve is closed and a pressure p₀ is present in the control space 4 of the valve. When an activation voltage is applied, the piezoactuator 1 is deflected, the valve piston 3 raises a valve ball 5 from its seat counter to the action of a reset spring 6, thereby opening the valve, and a pressure p₁ results in the control space.

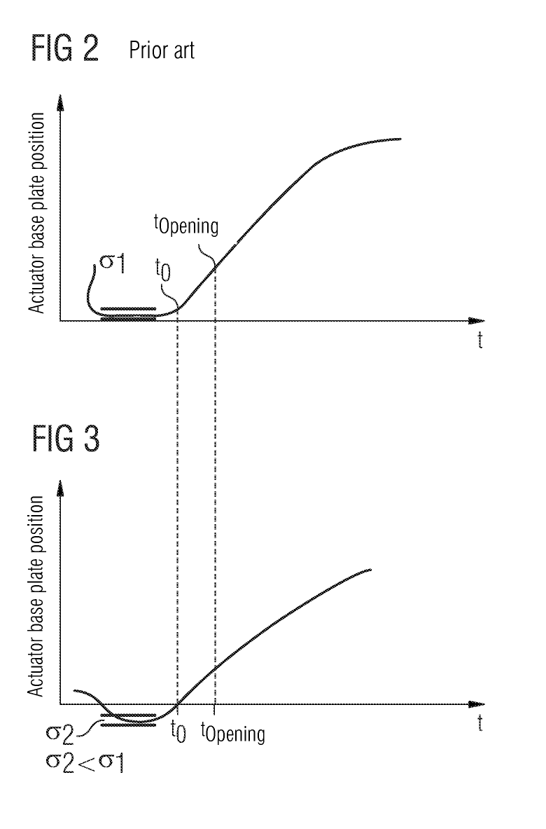

FIG. 2 shows a diagram illustrating the position of the actuator base plate 7 of a piezoactuator 1 activated according to the prior art over time. When the current is first applied at time t₀, the piezoactuator 1 starts to lengthen, so that the actuator base plate 7 starts to act on the actuating element 3 after a specified time interval that is a function of the idle stroke. The hydraulic opening time of the on/off valve of the injector is then reached at time t_{Opening}. The predetermined initial position (zero position) of the actuator base plate 7 before current application is however oscillation-prone for the reasons set out above, in other words it has the variance σ₁ shown in FIG. 2, which is reflected in a corresponding variance of the start of opening of the valve, since every time the piezoactuator 1 is activated, a slightly different idle stroke, but one that is within the fluctuation range σ₁, becomes active. The predetermined initial position can also be achieved in a manner known per se by the application of negative current to the lengthened piezoactuator 1, in other words by a discharging.

According to various embodiments, predeflection of the piezoactuator 1 takes place directly before the actual injection event. This predeflection takes the actuator base plate 7 into a region that has increased positional stability in relation to reproducibility. The predeflection can advantageously be realized as a retraction of the piezoactuator 1 due to application of negative current and is illustrated in FIG. 3. In order to achieve the same hydraulic opening time t_{Opening} of the on/off valve as with conventional activation, the start of current application should be moved forward due to the longer but defined actuator path, see the trough-shaped negative part of the curve illustrated in FIG. 3, which shows the retraction of the actuator base plate 7 into a new initial position. This new initial position is characterized by a variance σ₂, which is smaller than the variance σ₁ assigned to the predetermined initial position. This is because the predeflection causes the proportion of actuator force in the force equation comprising the tube spring, membrane stress, membrane space pressure, thermal stress and friction to rise in relation to external influences (ambient temperature, pressure) and in relation to previous history, in other words the previous injection, which result in oscillation-prone actuator base plate positions. This means that the proportion of forces that can be controlled in a defined manner rises in relation to (stochastically) externally controlled forces. The initial position of the actuator base plate becomes more stable and the variance of the actual start of valve opening is therefore less, with the result that injection precision increases as desired.

What is claimed is:

1. A method for activating a piezoactuator in a fuel injector, wherein the electrically activatable piezoactuator transmits a longitudinal movement to an actuating element, the method comprising:
setting a predetermined idle stroke between an actuator base plate and the actuating element, as a function of a predetermined initial position of the actuator base plate before activation, and
activating the piezoactuator, the actuator base plate of which is in the predetermined oscillation-prone initial position, directly before injection so that a defined predeflection of the piezoactuator occurs, such that the actuator base plate assumes a new, less oscillation-prone initial position before the subsequent injection.

2. The method according to claim 1, wherein negative current is applied to the piezoactuator to bring about the predeflection, so that the actuator base plate is retracted into a defined new position.

3. The method according to claim 2, wherein for activation purposes the piezoactuator is subjected in each instance to an applied current profile, which brings about the defined predeflection and the subsequent injection, the start of current application being moved so far forward that a predetermined hydraulic opening time of a valve of the injector is achieved despite predeflection.

4. The method according to claim 3, wherein the charging current profile of the piezoactuator over time is influenced by way of the parameters of the current application profile so that the desired positions of the actuator base plate are assumed at the desired times.

5. A system for activating a piezoactuator in a fuel injector, comprising
an electrically activatable piezoactuator transmitting a longitudinal movement to an actuating element, the piezoactuator having a predetermined idle stroke between an actuator base plate and the actuating element, as a function of a predetermined initial position of the actuator base plate before activation, and
a control device coupled with said piezoactuator and, operable to:
activate the piezoactuator, the actuator base plate of which is in the predetermined oscillation-prone initial position, directly before injection so that a defined predeflection of the piezoactuator occurs, such that the actuator base plate assumes a new, less oscillation-prone initial position before the subsequent injection.

6. The system according to claim 5, wherein the control device applies negative current to the piezoactuator to bring about the predeflection, so that the actuator base plate is retracted into a defined new position.

7. The system according to claim 6, wherein for activation purposes the piezoactuator is subjected in each instance to an applied current profile, which brings about the defined predeflection and the subsequent injection, the start of current application being moved so far forward that a predetermined hydraulic opening time of a valve of the injector is achieved despite predeflection.

8. The system according to claim 7, wherein the charging current profile of the piezoactuator over time is influenced by way of the parameters of the current application profile so that the desired positions of the actuator base plate are assumed at the desired times.

9. The system according to claim 5, wherein the actuating element is a valve from a valve seat.

10. The system according to claim 9, wherein the valve is biased towards the valve seat by a spring.

11. The system according to claim 7, wherein the electrically activatable piezoactuator has a first length when no activation voltage is applied to the piezoactuator.

12. The system according to claim 7, wherein the proportion of an actuator force in a force equation comprising at least one of the tube spring, membrane stress, membrane space pressure, thermal stress and friction rises in relation to external influences when said predeflection takes place.

13. A method for activating a piezoactuator in a fuel injector, wherein the electrically activatable piezoactuator transmits a longitudinal movement to an actuating element, the method comprising:
applying no voltage the piezoactuator, wherein the actuator base plate rests in a predetermined oscillation-prone initial position,
determining an offset time;
applying a first voltage to the piezoactuator, wherein the piezoactuator retracts said actuator base plate at a time determined by said offset time, and
subsequently applying a second voltage to said piezoactuator to move said piezoactuator thereby opening a valve in said fuel injector.

14. The method according to claim 13, wherein the step of applying a first voltage produces a negative current in the piezoactuator to bring about a predeflection, so that the actuator base plate is retracted into a defined new position.

15. The method according to claim 14, wherein for activation purposes the piezoactuator is subjected in each instance to an applied current profile, which brings about the defined predeflection and the subsequent injection, the start of current application being moved so far forward that a predetermined hydraulic opening time of a valve of the injector is achieved despite predeflection.

16. The method according to claim 15, wherein the charging current profile of the piezoactuator over time is influenced by way of the parameters of the current application profile so that the desired positions of the actuator base plate are assumed at the desired times.
